(19) United States
(12) Patent Application Publication
(10) Pub. No.: US 2011/0313582 A1
(43) Pub. Date: Dec. 22, 2011

(54) CLASSIFYING DEVICES BY FINGERPRINTING VOLTAGE AND CURRENT CONSUMPTION

(75) Inventors: Friedrich van Megen, Wurselen (DE); Ulrich Mueller, Redmond, WA (US)

(73) Assignee: MICROSOFT CORPORATION, Redmond, WA (US)

(21) Appl. No.: 12/819,201

(22) Filed: Jun. 20, 2010

(51) Int. Cl. G06F 1/26

(52) U.S. Cl. 700/292; 700/297; 713/340

(57) ABSTRACT

Architecture that automatically classifies and identifies devices via device “fingerprints” once plugged into a power receptacle. A digital sample of electrical information such as current or current and voltage is obtained at the power receptacle for a plugged-in device. A device signature is generated that is specific to the device based on the associated electrical information. The device can then be identified based on the signature. The device can also be categorized as a class of device based on the signature. Policies can be created and applied based on the signatures and/or device classes. The policies can control power to the devices via the outlets, deny power based on specific times or configurations, location and non-power related parameters.

### BACKGROUND

A major trend in reducing power consumption is to monitor power consumption of appliances and to enforce shutting down devices that are not required by the user. Typical examples are to limit the uptime of an air conditioning unit to times when cooling is normally desired (e.g., midday) or to switch off unnecessarily running appliances when the user is not at home. The underlying approach is to reduce overall power consumption by assigning predefined policies to all power outlets of the entire home/building.

However, a problem is that a policy-based approach relies on a skilled administrator to maintain an up-to-date mapping between power outlet and devices. This approach is error prone, particularly in a private home environment where a family member is tasked to upkeep this information.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture decouples the heretofore static relation between the power outlet and power-consumption policy by automatically classifying and identifying (“fingerprinting”) devices once plugged into a power receptacle. The identification process obtains a digital sample of current or current and voltage at the power receptacle for a plugged-in device. The data is then classified based on existing data obtained from previously registered (fingerprinted) devices to identify the currently connected power consuming device. Where automatic identification is problematic due to missing fingerprints and/or device characteristics, the device can be assigned by fingerprinting the device category to a class of consumer devices instead.

The architecture enables new scenarios such as a parent defining a power policy for child entertainment that enables children to use a gaming device, for example, on a per-time basis (e.g., one hour per day), regardless of which receptacle the children plug the gaming device, but can allow a desk lamp plugged into the same multi-receptacle power panel to work the entire day. In other words, management of a situation where a user swaps power outlets of the gaming device and the desk lamp will not allow circumvention of the intent to restrict playtime (e.g., by temporarily disabling affected power outlets).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a device management system in accordance with the disclosed architecture.

FIG. 2 illustrates an alternative embodiment of a device management system that employs a policy component for creating and applying policies based on the identifications.

FIG. 3 illustrates a system that employs a smart power outlet that employs the device management architecture.

FIG. 4 illustrates a device management system that fingerprints and categorizes devices in accordance with the disclosed architecture.

FIG. 5 illustrates a device management method in accordance with the disclosed architecture.

FIG. 6 illustrates further aspects of the method of FIG. 5.

FIG. 7 illustrates a block diagram of a computing system that executes policies and device management in accordance with the disclosed architecture.

### DETAILED DESCRIPTION

The disclosed architecture improves usability and performance (e.g., in smart outlets) by assisting a power-control system in identifying energy consuming devices connected to power outlets and for which the signature and mapping has not changed so as to apply the power and usage policies as desired. In support thereof, devices connected and drawing power from the outlets are fingerprinted and/or categorized for unique identification based on analysis and development of electrical profiles for the devices. The policies applied can switch devices on and off, deny device power based on the class of device, and deny device power based on location and non-power related policies, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

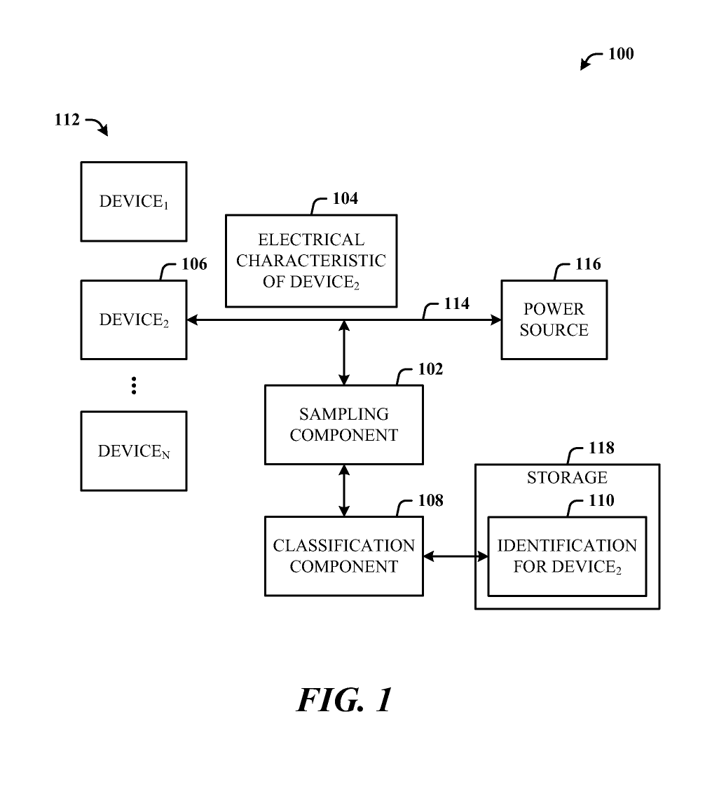

FIG. 1 illustrates a device management system 100 in accordance with the disclosed architecture. The system 100 includes a sampling component 102 that digitally samples an electrical characteristic 104 of an energy consuming device 106 at a location, and a classification component 108 that creates a unique identification 110 based on classification of the electrical characteristic 104 of the energy consuming device 106. The identification 110 differentiates the energy consuming device 106 from other energy consuming devices 112 at the location.

The classification component 108 classifies the energy consuming device 106 based on sampling of electrical characteristics that includes at least a current characteristic and optionally, an additional voltage characteristic. Note that additional sensing inputs could also be utilized such as time of day, scheduling information from a scheduling program (e.g., user is out-of-office, at another meeting, etc.). The sampling component 102 initiates sampling of the electrical characteristic 104 in response to an event that causes a surge in energy consumption by the energy consuming device 106. For example, during a power-on phase, in-rush current and voltage perturbations can be sensed and utilized to trigger sampling and classification.

Other trigger events can be associated with transitioning the device 106 from a standby mode to a full-power mode. Generally, sampling can be performed when the power profile of the device 106 is stressed by events that cause changes in the electrical consumption that are reflected in voltage and/or current draw, and which are useful in creating a unique signature for the device 106. The identification is based on classification of the electrical characteristic in the time domain and/or the frequency domain.

The sampling can be made directly on the power feed 114 from a power source 116 to the device 106. The power source 116 can be the general AC grid or a battery source. In one implementation, each receptacle of a power outlet panel has a dedicated sampling component and classification component for the device connected to that receptacle that can be triggered to perform the sampling and classification.

In another implementation, each outlet panel (that may have multiple receptacles) has a single sampling component and classification component for sampling devices connected to the receptacles of the outlet panel.

In yet another implementation, a circuit (having several multi-receptacle power outlets) can have a dedicated sampling component and classification component combination to process the connected devices for signatures and identification. The identifications sampled and created for each of the devices 112 can be stored in a storage 118 for update, and retrieval for other purposes.

In still another implementation, the signature generation process (sampling and classification) can be performed at a central location where the user plugs the device into a receptacle for “fingerprinting”, and once the signature is obtained, the device is then relocated to the desired location (outlet).

It is desirable to sample and analyze the current and/or voltage waveforms at the same points in time across all devices so the signatures can be normalized. Thus, the power feed can be monitored and sampling triggered at the same point in time for all devices for analysis and classification. In one implementation, the zero-crossing point of the voltage signal of the power feed can be the trigger to turn on a device and then perform sampling and analysis to develop the signature (fingerprint).

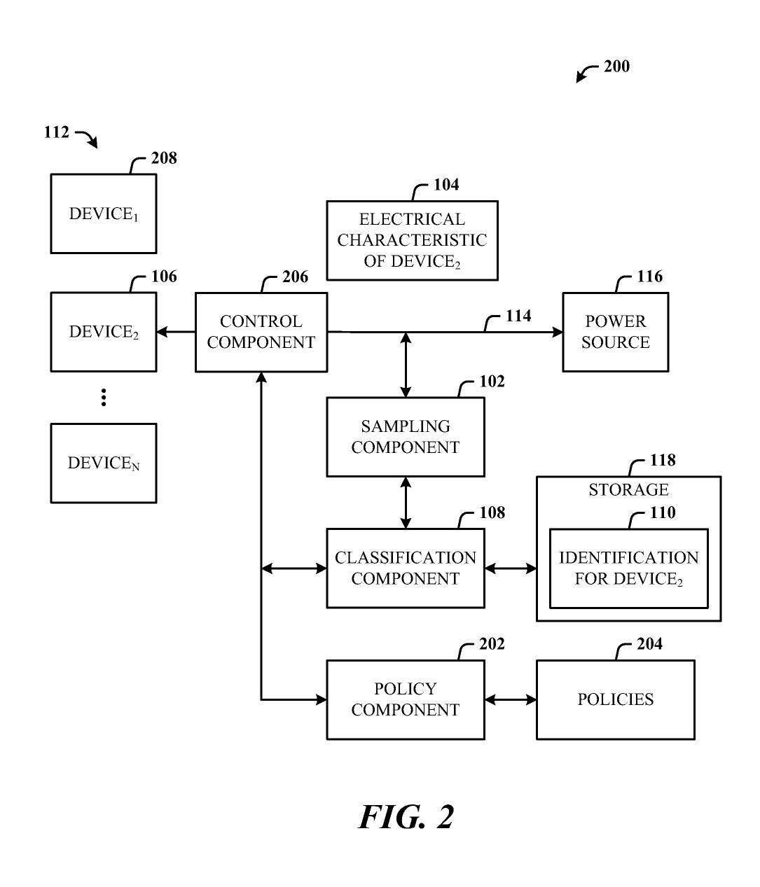

FIG. 2 illustrates an alternative embodiment of a device management system 200 that employs a policy component 202 for creating and applying policies 204 based on the identifications. A policy applied to the energy consuming device 106 can control power to the energy consuming device 106 to power-off the device 106. In support thereof, a control component 206 is provided to drop power to the device 106. The policy component 202 controls power to devices (via the policies 204) related to the energy consuming device 106 based on the policy.

The policy component 202 can apply a policy that denies power to members of a class of devices 112. For example, if a first device 208 and the device 106 are classified as gaming devices, and connected to the same outlet panel over which the control component 206 exercises control, a policy can be applied that powers off the devices (106 and 208) of the class. The policy component 202 can apply a policy that manages power to the energy consuming device 106 based on non-power-related criteria (e.g., an entertainment device, time of day, range of time, etc.).

The disclosed architecture can be utilized with “smart” outlets (that employ control logic). Existing smart power outlets can be limited to switching on/off the devices by cutting the power. Since the power source 116 is typically AC (alternating current) power at 50 Hz or 60 Hz, measuring the power is typically performed by measuring the voltage and current at a fixed sampling rate and integrating the product (of voltage and current) over time, thereby providing the average power consumption for a time interval. The fine-grained timing information is usually not used explicitly. Thus, only the average power consumption of the devices is used for monitoring and further processing.

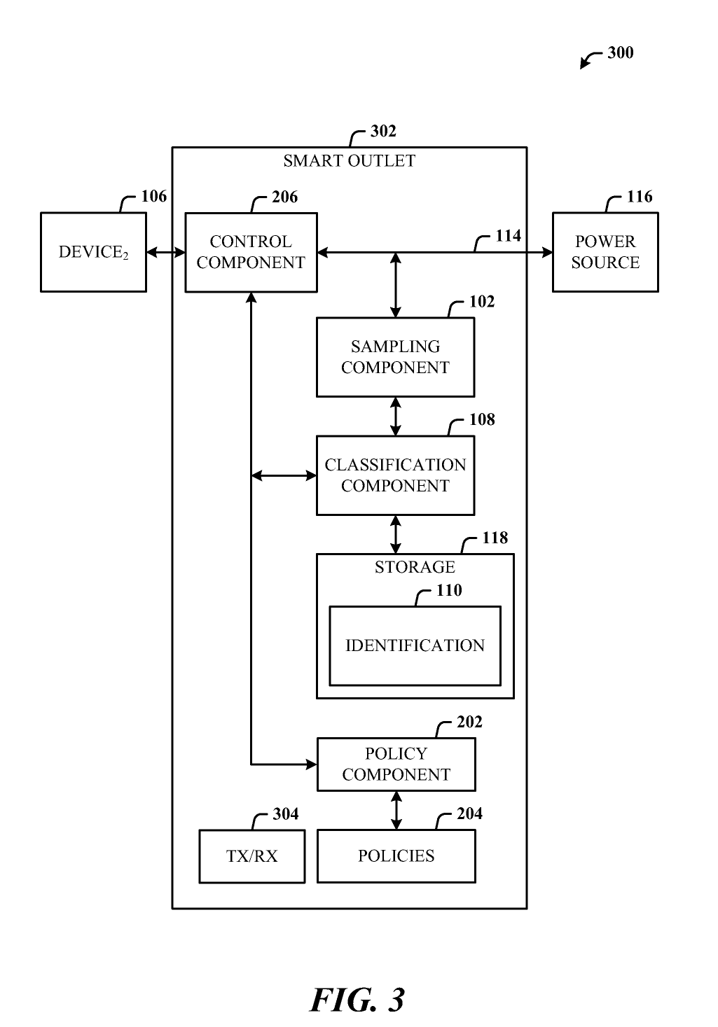

FIG. 3 illustrates a system 300 that employs a smart power outlet 302 that employs the device management architecture. The signature of the measured voltage signal and current signal reveals much more characteristics of the connected devices than the average power consumption. The current signal characterizes the connected devices, and can be analyzed in relation to the provided voltage. In some appliances such an electric kettle that simply uses a coil to heat water, the kettle presents a substantially purely resistive load, and thus, a sample current measurement of a single phase of an electric kettle is relatively clean insofar as signal analysis is concerned. If there are a number of appliances that present a similar power profile for analysis, it can be more difficult to uniquely define a signature that distinguishes one such appliance or device from another. In this case, the devices and appliances can be assigned to classes, rather than uniquely identified. Thus, control can be by a policy that applies to the class.

The signal of a device oftentimes is the combination of multiple elementary signals such as ohmic resistance, capacitive units, switching units, and so on. For a device where the load is not purely resistive, such as a portable computer, a more complex power profile provides the basis for unique identification of that device. In general, the current profile of the device can be characterized by various metrics such as the signal height, phase shift, location of signal peaks, relative location of the peaks, variance, and other metrics as desired.

Moreover, the electrical fingerprint (signature) can be performed at a single cycle or over multiple cycles, and then taking the average signal as the basis for further processing.

In addition to the information that is available after the device has been powered for some time, data collected immediately when power is applied carries additional information about the device. However, the power-on signal may not be readily available for measurement in scenarios where the device remains in the powered state continuously. However, even such devices may eventually switch power states, such as from powered mode to standby mode (a change in power consumption) and from standby mode to powered mode (a surge in power consumption). The power-on signal may also differ depending on the amount of time the device has been switched off (e.g., due to cooling effects). While this complicates the usage of the power-on signal, the signal still provides an additional unique input to the fingerprinting algorithm.

The current and voltage information can be sampled with a high resolution (e.g., 8-bit, 10-bit, etc.) to identify devices and/or device classes that are plugged into a power outlet. Sampling can be explicitly triggered at switching events (e.g., switching a device on, exiting standby mode, etc.) to retrieve a unique switch response (e.g., fluctuation) that can be used for fingerprinting. An example technique for obtaining uniform fingerprints is to switch on power at the outlet at a fixed point of the AC voltage phase. This can require that the user to switch on the power outlet instead of the device itself. A dual approach is that the outlet only provides very limited power to detect when a plugged-in device switches from standby to power-on, and then artificially switches the outlet off for a short time and on at the desired voltage phase.

Signal decomposition algorithms can be applied on sampled data that contains an overlay of several devices to allow decomposition of the multiple devices plugged into one power outlet panel.

Device fingerprints can be accumulated into a library such that device classes can be developed for finding and identifying new devices. The library can comprise the timing information of current and voltage data, the frequency domain data of current measurements, derived features from the time and frequency domain (e.g., distance between “interesting points” in the plots) such as time from start of a sine wave until first non-null reading, number of null-transitions within one cycle, delta time of raise/fall times (first derivative), variation of “interesting” data (e.g., after folding several sine-wave durations), and number of peaks in the frequency domain, peak distance and peak strength.

The device identification can be used to apply power policies to a set of power outlets, including but not limited to, switching on/off related devices based on a policy set by the user (e.g., a master/slave switch), denying devices power at specific times/configurations (e.g., prohibiting use of an air conditioner when the power load on the power grid is high) based on the class of device, and denying power to devices based on device location and non-power related policies (e.g., parents prohibit use of entertainment devices in child bedrooms at specific times and/or after a predefined duration has expired).

The outlet 302 can also include a communications capability such as a transceiver 304 communicating with a central computer system for sending instructions to the outlet, and receiving data back. The transceiver can facilitate wired, and/or wireless communications with the computer system or a suitable central control panel where a user interacts to effect changes and view information about the outlets and sets policies for device control.

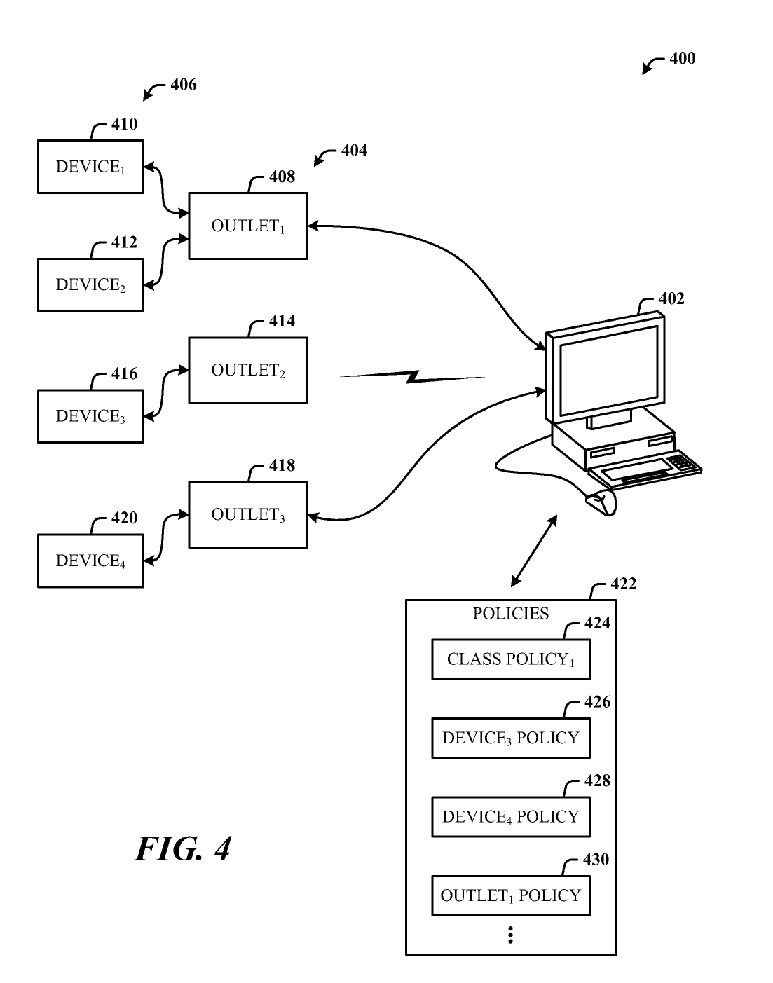

FIG. 4 illustrates a device management system 400 that fingerprints and categorizes devices in accordance with the disclosed architecture. The system 400 includes a computer system 402 functioning at least as a control system that communicates with outlets 404 to which devices 406 are connected. For example, a first outlet 408 has connected thereto a first device 410 and a second device 412. A second outlet 414 has connected thereto a third device 416, and a third outlet 418 has connected thereto a fourth device 420. The first outlet 408 and third outlet 418 both interface to the computer system 402 by a wired connection, and the second outlet 414 communicates with the computer system 402 via a wireless link.

The computer system 402 processes any number of policies 422, which can include a class policy 424, a device policy 426 specifically for the third device 416, a device policy 428 for the fourth device 420, and an outlet policy 430 for the first outlet 408. Other polices can be developed and applied as desired.

In operation, the outlet policy 430 can define that both the first device 410 and the second device 412 are controlled in tandem at the first outlet 408. For example, if the first device 410 and second device 412 are located in a single location (child bedroom) and the parent wants to disable power to these devices (410 and 412) to prohibit access to entertainment (e.g., television, computer games, etc.) during specific times of the day, the outlet policy 430 can drop power to the entire first outlet (and associated receptacles). This can be accomplished by categorizing the devices (410 and 412) as a class of device (entertainment devices) rather than developing specific signatures for each of the devices, although the signatures can be developed as well.

The class policy 424 can be applied to a class of devices on different outlets. For example, if the first device 410 and the third device 416 are in the child's room but on different outlets, the class policy 424 can be employed to drop power to the devices (410 and 416) at specified times.

The same devices (410 and 416) can have specific signatures that allow the policies (device policy 426 and a policy (not shown) for the first device 410) to be executed that drop power no matter which outlet the devices (410 and 416) are connected to and drawing power.

The signatures can be utilized for other purposes. For example, based on periodic analysis of the electrical characteristics, and trending of the power consumption, it can be predicted that a particular device may fail if the power consumption is gradually increasing.

In another application of the use of signatures, an abrupt power draw can indicate an activity associated with the device. For example, if the device is a freezer, and the freezer door is left open, the power consumption will increase to maintain the freezer temperature. This can be an indication that that the device should be inspected to determine the cause of the increased power consumption.

In other words, the level of detail in the power profile established for a particular device can provide a means for analyzing the causes for changes in power consumption.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

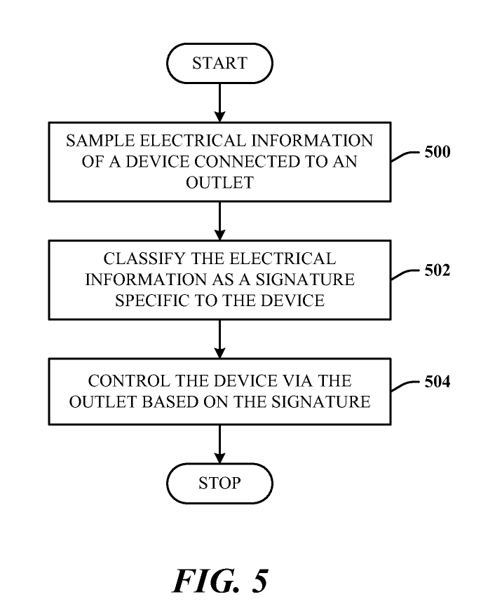

FIG. 5 illustrates a device management method in accordance with the disclosed architecture. At 500, electrical information of a device connected to an outlet is sampled. At 502, the electrical information is classified as a signature specific to the device. At 504, the device is controlled via the outlet based on the signature.

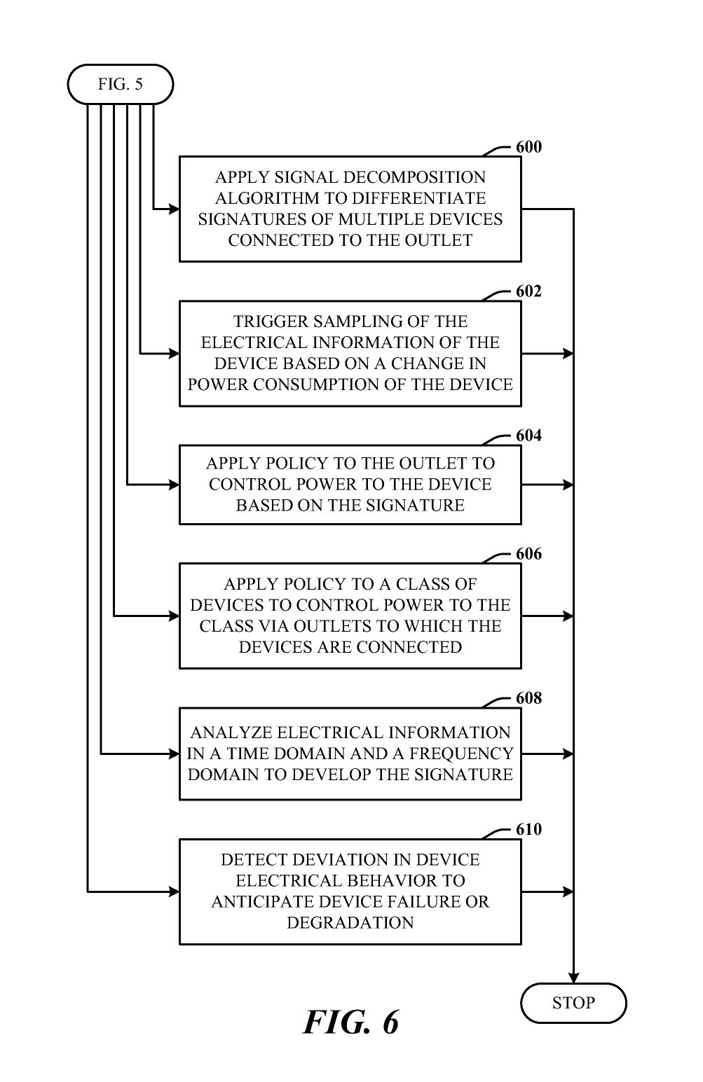

FIG. 6 illustrates further aspects of the method of FIG. 5. Note that the arrowing indicates that each block represents a step that can be included, separately or in combination with other blocks, as additional aspects of the method represented by the flow chart of FIG. 5. At 600, a signal decomposition algorithm is applied to differentiate signatures of multiple devices connected to the outlet. At 602, sampling of the electrical information of the device is triggered based on a change in power consumption of the device. At 604, a policy is applied to the outlet to control power to the device based on the signature. At 606, a policy is applied to a class of devices to control power to the class via outlets to which the devices are connected. At 608, the electrical information is analyzed in a time domain and a frequency domain to develop the signature. At 610, deviation in device electrical behavior can be detected to anticipate device failure or degradation. For example, if the device begins to draw additional power, this can be an indication of degradation in device electrical elements (e.g., capacitors, etc.) and eventual device failure.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

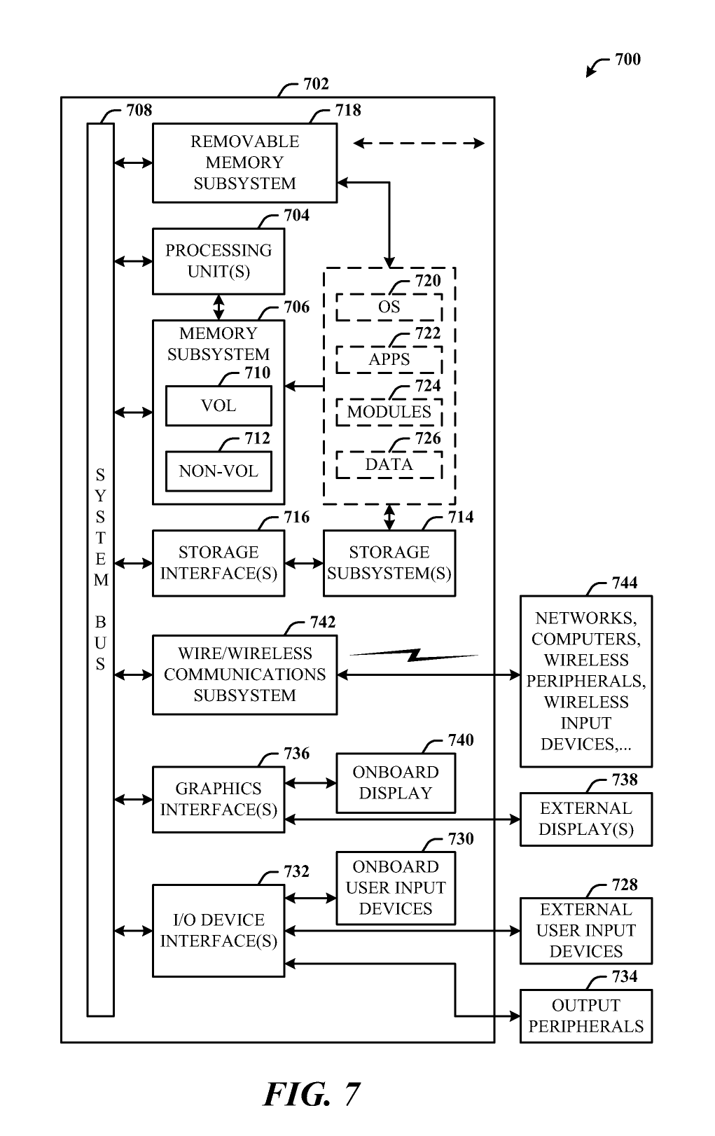

Referring now to FIG. 7, there is illustrated a block diagram of a computing system 700 that executes policies and device management in accordance with the disclosed architecture. In order to provide additional context for various aspects thereof, FIG. 7 and the following description are intended to provide a brief, general description of the suitable computing system 700 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 700 for implementing various aspects includes the computer 702 having processing unit(s) 704, a computer-readable storage such as a system memory 706, and a system bus 708. The processing unit(s) 704 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 706 can include computer-readable storage (physical storage media) such as a volatile (VOL) memory 710 (e.g., random access memory (RAM)) and non-volatile memory (NON-VOL) 712 (e.g., ROM, EPROM, EEPROM, etc.). A basic input/output system (BIOS) can be stored in the non-volatile memory 712, and includes the basic routines that facilitate the communication of data and signals between components within the computer 702, such as during startup. The volatile memory 710 can also include a high-speed RAM such as static RAM for caching data.

The system bus 708 provides an interface for system components including, but not limited to, the system memory 706 to the processing unit(s) 704. The system bus 708 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 702 further includes machine readable storage subsystem(s) 714 and storage interface(s) 716 for interfacing the storage subsystem(s) 714 to the system bus 708 and other desired computer components. The storage subsystem(s) 714 (physical storage media) can include one or more of a hard disk drive (HDD), a magnetic floppy disk drive (FDD), and/or optical disk storage drive (e.g., a CD-ROM drive DVD drive), for example. The storage interface(s) 716 can include interface technologies such as EIDE, ATA, SATA, and IEEE 1394, for example.

One or more programs and data can be stored in the memory subsystem 706, a machine readable and removable memory subsystem 718 (e.g., flash drive form factor technology), and/or the storage subsystem(s) 714 (e.g., optical, magnetic, solid state), including an operating system 720, one or more application programs 722, other program modules 724, and program data 726.

The one or more application programs 722, other program modules 724, and program data 726 can include the functionality included provided in the computing system 402 to control the smart outlets, develop and download policies to the outlets, process the policies from the computing system 402 for control of the outlets and devices, and so on.

Generally, programs include routines, methods, data structures, other software components, etc., that perform particular tasks or implement particular abstract data types. All or portions of the operating system 720, applications 722, modules 724, and/or data 726 can also be cached in memory such as the volatile memory 710, for example. It is to be appreciated that the disclosed architecture can be implemented with various commercially available operating systems or combinations of operating systems (e.g., as virtual machines).

The storage subsystem(s) 714 and memory subsystems (706 and 718) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 702 and includes volatile and non-volatile internal and/or external media that is removable or non-removable. For the computer 702, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 702, programs, and data using external user input devices 728 such as a keyboard and a mouse. Other external user input devices 728 can include a microphone, an IR (infrared) remote control, a joystick, a game pad, camera recognition systems, a stylus pen, touch screen, gesture systems (e.g., eye movement, head movement, etc.), and/or the like. The user can interact with the computer 702, programs, and data using onboard user input devices 730 such a touchpad, microphone, keyboard, etc., where the computer 702 is a portable computer, for example. These and other input devices are connected to the processing unit(s) 704 through input/output (I/O) device interface(s) 732 via the system bus 708, but can be connected by other interfaces such as a parallel port, IEEE 1394 serial port, a game port, a USB port, an IR interface, etc. The I/O device interface(s) 732 also facilitate the use of output peripherals 734 such as printers, audio devices, camera devices, and so on, such as a sound card and/or onboard audio processing capability.

One or more graphics interface(s) 736 (also commonly referred to as a graphics processing unit (GPU)) provide graphics and video signals between the computer 702 and external display(s) 738 (e.g., LCD, plasma) and/or onboard displays 740 (e.g., for portable computer). The graphics interface(s) 736 can also be manufactured as part of the computer system board.

The computer 702 can operate in a networked environment (e.g., IP-based) using logical connections via a wired/wireless communications subsystem 742 to one or more networks and/or other computers. The other computers can include workstations, servers, routers, personal computers, microprocessor-based entertainment appliances, peer devices or other common network nodes, and typically include many or all of the elements described relative to the computer 702. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 702 connects to the network via a wired/wireless communication subsystem 742 (e.g., a network interface adapter, onboard transceiver subsystem, etc.) to communicate with wired/wireless networks, wired/wireless printers, wired/wireless input devices 744, and so on. The computer 702 can include a modem or other means for establishing communications over the network. In a networked environment, programs and data relative to the computer 702 can be stored in the remote memory/storage device, as is associated with a distributed system. It will be appreciated that the network connections shown are exemplary and other means of establishing a communications link between the computers can be used.

The computer 702 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device management system, comprising:
a sampling component that digitally samples an electrical characteristic of an energy consuming device at a location; and
a classification component that creates a unique identification based on classification of the electrical characteristic of the energy consuming device, the unique identification differentiates the energy consuming device from other energy consuming devices at the location.

2. The system of claim 1, wherein the classification component classifies the energy consuming device based on sampling of current or, current and voltage.

3. The system of claim 1, wherein the sampling component initiates sampling of the electrical characteristic in response to an event that causes a surge in energy consumption by the energy consuming device.

4. The system of claim 1, wherein the identification is based on classification of the electrical characteristic in a time domain.

5. The system of claim 1, wherein the identification is based on classification of the electrical characteristic in a frequency domain.

6. The system of claim 1, further comprising a policy component for creation and execution of a policy based on the identification, the policy applied to the energy consuming device to control power to the energy consuming device.

7. The system of claim 6, wherein the policy component controls power to devices related to the energy consuming device based on the policy.

8. The system of claim 6, wherein the policy component applies a policy that denies power to members of a class of devices.

9. The system of claim 6, wherein the policy component applies a policy that manages power to the energy consuming device based on non-power-related criteria.

10. A device management system, comprising:
a sampling component of an outlet that obtains a digital sample of at least one of a current signal, or current signal and voltage signal, of an energy consuming device connected to the outlet, the energy consuming device and other energy consuming devices at a location; and
a classification component of the outlet that creates a signature from the digital sample and associates the signature with the energy consuming device, the signature differentiates the energy consuming device from other energy consuming devices at the location.

11. The system of claim 10, wherein the sampling component initiates sampling in response to a change in energy consumption by the energy consuming device.

12. The system of claim 10, wherein the signature is based on analysis of the digital sample in at least one of a time domain or a frequency domain.

13. The system of claim 10, wherein the signature is based on analysis of parameters associated with the current signal, the parameters are at least one of time from start of signal to first non-null reading, number of null-transitions with one cycle time, delta time of rise/fall times, variation data associated with multiple signal cycles, or peak data in a frequency domain.

14. The system of claim 10, further comprising a policy component that applies a policy which at least one of controls power to devices related to the energy consuming device, denies power to members of a class of devices, or manages power to the energy consuming device based on non-power-related criteria.

15. A device management method, comprising:
sampling electrical information of a device connected to an outlet;
classifying the electrical information as a signature specific to the device; and
controlling the device via the outlet based on the signature.

16. The method of claim 15, further comprising applying a signal decomposition algorithm to differentiate signatures of multiple devices connected to the outlet.

17. The method of claim 15, further comprising triggering sampling of the electrical information of the device based on a change in power consumption of the device.

18. The method of claim 15, further comprising applying a policy to the outlet to control power to the device based on the signature.

19. The method of claim 15, further comprising applying a policy to a class of devices to control power to the class via outlets to which the devices are connected.

20. The method of claim 15, further comprising detecting deviation in device electrical behavior to anticipate device failure or degradation.
